(19) United States
(12) Patent Application Publication
(10) Pub. No.: US 2026/0261743 A1
(43) Pub. Date: Sep. 3, 2026

(54) METHOD, APPARATUS, DEVICE AND STORAGE MEDIUM FOR VIDEO GENERATION

(71) Applicant: Beijing Zitiao Network Technology Co., Ltd., Beijing (CN)

(72) Inventors: Jie Ling, Beijing (CN); Qianbin He, Beijing (CN); Jianwen Jiang, Beijing (CN); Gaojie Lin, Beijing (CN); Jiaqi Yang, Beijing (CN); Zerong Zheng, Beijing (CN); Chao Liang, Beijing (CN); Chao Li, Beijing (CN)

(21) Appl. No.: 19/555,618

(22) Filed: Mar. 3, 2026

(30) Foreign Application Priority Data
Mar. 3, 2025 (CN) 202510246535.5

(51) Int. Cl. H04N 21/81; H04N 21/2743

(52) U.S. Cl. CPC H04N 21/816; H04N 21/2743; H04N 21/8106

(57) ABSTRACT

According to embodiments of the disclosure, a method, an apparatus, an electronic device, and a storage medium for video generation are provided. The method includes: presenting a configuration interface in response to receiving a video generation request, the configuration interface including a first control and a second control; obtaining configuration information via the configuration interface, the configuration information including: a reference image obtained via the first control, and a reference text or a reference audio obtained via the second control, where the reference image includes a predetermined object; and providing video content generated based on the configuration information, the video content including a first movement associated with a first region of the reference image and a second action associated with a second region of the reference image, the first region including a facial region, and the first movement corresponding to the reference text or the reference audio.

### CROSS-REFERENCE

The present application claims priority to Chinese Patent Application No. 202510246535.5, filed on March 03, 2025, and entitled “METHOD, APPARATUS, DEVICE AND STORAGE MEDIUM FOR VIDEO GENERATION”, the entirety of which is incorporated herein by reference.

### TECHNICAL FIELD

Example embodiments of the present disclosure generally relate to the field of computers, and in particular, to a method, an apparatus, a device, and a computer-readable storage medium for video generation.

### BACKGROUND

With the development of computer technologies, some machine learning technologies support users to drive images through control signals to generate dynamic video content. For example, a user may drive a digital human to perform actions corresponding to an audio signal by inputting the audio signal.

### SUMMARY

In a first aspect of the present disclosure, a method for video generation is provided. The method includes: presenting a configuration interface in response to receiving a video generation request, the configuration interface including a first control and a second control; obtaining configuration information via the configuration interface, the configuration information including: a reference image obtained via the first control, and a reference text or a reference audio obtained via the second control, where the reference image includes a predetermined object; and providing video content generated based on the configuration information, the video content including a first movement associated with a first region of the reference image and a second action associated with a second region of the reference image, the first region including a facial region, and the first movement corresponding to the reference text or the reference audio.

In a second aspect of the present disclosure, an apparatus for video generation is provided. The apparatus includes: a presentation module configured to present a configuration interface in response to receiving a video generation request, the configuration interface including a first control and a second control; an obtaining module configured to obtain configuration information via the configuration interface, the configuration information including: a reference image obtained via the first control, and a reference text or a reference audio obtained via the second control, where the reference image includes a predetermined object; and a provision module configured to provide video content generated based on the configuration information, the video content including a first movement associated with a first region of the reference image and a second action associated with a second region of the reference image, the first region including a facial region, and the first movement corresponding to the reference text or the reference audio.

In a third aspect of the present disclosure, an electronic device is provided. The electronic device includes at least one processor; and at least one memory coupled to the at least one processor and storing instructions for execution by the at least one processor. When executed by the at least one processor, the instructions cause the electronic device to perform the method of the first aspect.

In a fourth aspect of the present disclosure, a non-transitory computer-readable storage medium is provided. The non-transitory computer-readable storage medium has stored thereon a computer program that is executable by a processor to implement the method of the first aspect.

It should be understood that the content described in this summary section is not intended to limit key features or important features of the embodiments of the present disclosure, nor is it intended to limit the scope of the present disclosure. Other features of the present disclosure will become readily apparent from the following description.

### BRIEF DESCRIPTION OF THE DRAWINGS

The foregoing and other features, advantages, and aspects of embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which embodiments of the present disclosure can be implemented;

FIG. 2A to FIG. 2D illustrate schematic diagrams of video generation interfaces according to some embodiments of the present disclosure;

FIG. 3 illustrates a schematic diagram of a video generation interface according to other embodiments of the present disclosure.

FIG. 4 illustrates a flowchart of an example process of video generation according to some embodiments of the present disclosure;

FIG. 5 illustrates a schematic structural block diagram of an apparatus for video generation according to some embodiments of the present disclosure;

FIG. 6 illustrates a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein; instead, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any sections/subsections provided herein are not restrictive. Various embodiments are described throughout the description, and any type of embodiment may be included under any section/subsection. In addition, the embodiments described in any section/subsection may be combined with any other embodiments described in the same section/subsection and/or different sections/subsections in any manner.

In the description of the embodiments of the present disclosure, the term "include/comprise" and similar terms should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other definitions, either explicit or implicit, may also be included below. The terms "first", "second", etc. may refer to different or same objects. Other definitions, either explicit or implicit, may also be included below.

The embodiments of the present disclosure may involve user data, data acquisition, and/or data usage. These aspects comply with applicable laws, regulations, and relevant provisions. In the embodiments of the present disclosure, all data collection, acquisition, processing, handling, forwarding, and usage are performed on the premise that the user is informed and has provided confirmation. Accordingly, when implementing the embodiments of the present disclosure, appropriate means shall be employed in accordance with applicable laws and regulations to inform the user of, and obtain the user’s authorization for, the types of data or information that may be involved, the scope of use, and the usage scenarios. The specific manner of notification and/or authorization may vary depending on actual circumstances and application scenarios, and the scope of the present disclosure is not limited in this regard.

In the solutions in the specification and the embodiments, if personal information processing is involved, such processing will be carried out only on the basis of a legitimate ground (for example, obtaining the consent of the personal information subject, or as necessary for the performance of a contract), and will be conducted only within the prescribed or agreed scope. A user’s refusal to allow the processing of personal information other than the necessary information required for basic functions will not affect the user’s use of the basic functions.

Conventionally, in scenarios of driving actions of a person using speech content, usually only a facial region of the person may be controlled to present corresponding actions, such as mouth actions. However, a video generated in this manner has poor realism.

Embodiments of the present disclosure propose a solution for video generation. According to the solution, in response to receiving a video generation request, a configuration interface is presented, the configuration interface including a first control and a second control; configuration information is obtained via the configuration interface, the configuration information including: a reference image obtained via the first control, and a reference text or a reference audio obtained via the second control, where the reference image includes a predetermined object; and video content generated based on the configuration information is provided, the video content including a first movement associated with a first region of the reference image and a second action associated with a second region of the reference image, the first region including a facial region, and the first movement corresponding to the reference text or the reference audio.

In this way, embodiments of the present disclosure can support driving the reference image using text or audio, and can not only drive the facial region to present corresponding movements, but also drive other regions of the reference image to present corresponding movements. Accordingly, embodiments of the present disclosure can improve the quality of the generated video content.

### Example Environment

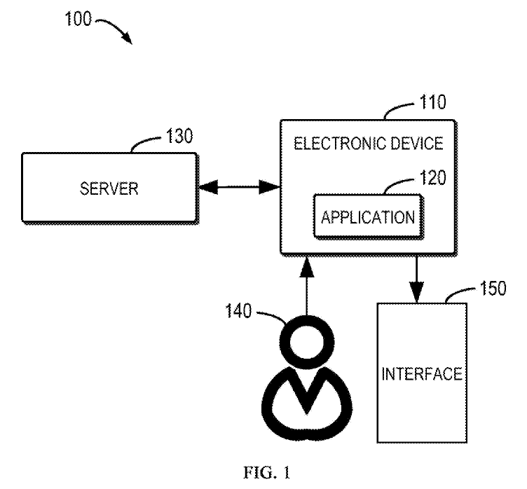

FIG. 1 illustrates a schematic diagram of an example environment 100 in which embodiments of the present disclosure can be implemented. As shown in FIG. 1, the example environment 100 may include an electronic device 110.

In the example environment 100, the electronic device 110 may run an application 120 that supports generation of video content. The application 120 may be any suitable type of application for generating video content, examples of which may include, but are not limited to: a video application, an editing application, or other suitable applications. A user 140 may interact with the application 120 via the electronic device 110 and/or its attached devices.

In the environment 100 of FIG. 1, if the application 120 is in an active state, the application 120 may provide a presentation interface 150 to the user 140.

In some embodiments, the electronic device 110 communicates with a server 130 to enable the provisioning of services of the application 120. The electronic device 110 may be any type of mobile terminal, fixed terminal, or portable terminal, including a mobile phone, desktop computer, laptop computer, notebook computer, netbook computer, tablet computer, media computer, multimedia tablet, handheld computer, portable game terminal, VR/AR device, Personal Communication System (PCS) device, personal navigation device, Personal Digital Assistant (PDA), audio/video player, digital camera/camcorder, positioning device, television receiver, radio receiver, e-book device, game device, or any combination of the foregoing, including accessories and peripherals thereof or any combination thereof. In some embodiments, the electronic device 110 may also support any type of interface for a target user (such as a “wearable” circuit).

The server 130 may be a standalone physical server, or a server cluster or distributed system composed of multiple physical servers, or a cloud server providing fundamental cloud computing services such as cloud services, cloud databases, cloud computing, cloud functions, cloud storage, network services, cloud communication, middleware services, domain name services, security services, content delivery networks, and big data and artificial intelligence platforms. The server 130 may include, for example, computing systems/servers such as mainframes, edge computing nodes, computing devices in a cloud environment, and so forth. The server 130 may provide background services for the application 120 that supports interface interaction in the electronic device 110.

A communication connection may be established between the server 130 and the electronic device 110. The communication connection may be established via a wired manner or a wireless manner. The communication connection may include, but is not limited to, a Bluetooth connection, a mobile network connection, a Universal Serial Bus (USB) connection, a Wireless Fidelity (WiFi) connection, etc. The embodiments of the present disclosure are not limited in this regard. In embodiments of the present disclosure, signaling interaction may be implemented between the server 130 and the electronic device 110 via the communication connection therebetween.

It should be understood that the structure and functions of the respective elements in the environment 100 are described solely for illustrative purposes, without implying any limitation on the scope of the present disclosure.

Hereinafter, some example embodiments of the present disclosure will be described still with reference to the accompanying drawings.

### Example Interaction

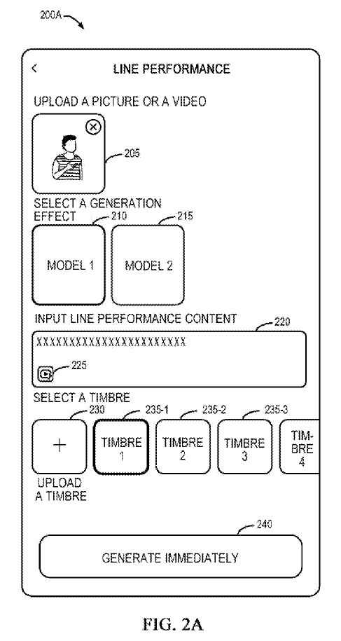

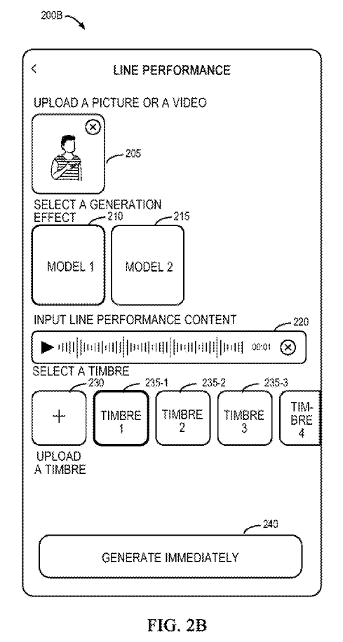

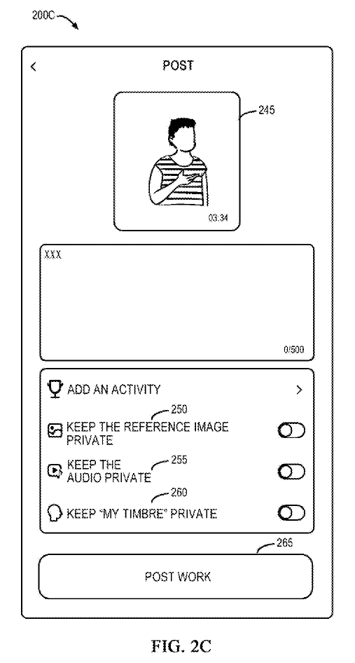

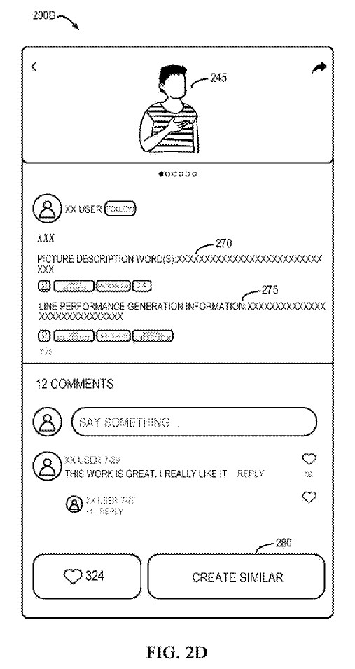

An example interaction process according to embodiments of the present disclosure will be described below with reference to FIG. 2A to FIG. 2D. FIG. 2A to FIG. 2D illustrate example interfaces 200A to 200D according to some embodiments of the present disclosure, which may be provided by the electronic device 110 shown in FIG. 1.

In some scenarios, the electronic device 110 may have the application 120 for video generation installed thereon, or the electronic device 110 may also support accessing a preset website via a browser to view a corresponding interface. As an example, the application 120 may correspond to a media editing application or other suitable types of applications, which may support a user initiating a video generation request.

For example, the electronic device 110 may receive a user’s triggering of a video generation entry (or a video generation service) provided by the application 120, and may accordingly receive a video generation request from the user. As an example, such a video generation entry may correspond to a “line performance” service. Accordingly, the electronic device 110 may present the configuration interface 200A as shown in FIG. 2A.

As shown in FIG. 2A, the configuration interface 200A may include multiple controls for determining configuration information for generating video content. Such configuration information may also be referred to as a video generation parameter. The process of obtaining the configuration information will be described in detail below.

As shown in FIG. 2A, the configuration interface 200A may include a control 205 (also referred to as a first control). The control 205 may be used to obtain a reference image specified by a user.

In some examples, upon receiving a click on the control 205, the electronic device 110 may present a media selection interface to support the user selecting a picture or a video from a media library (e.g., a local album of the electronic device 110) as the reference image.

As another example, the electronic device 110 may also present an image capturing interface based on the click on the control 205, and may determine the captured photo or video as the reference image.

In some scenarios, in order to better drive the reference image, the electronic device 110 or the server 130 may further determine whether the obtained reference image includes a specific object. As an example, such a specific object may include a facial object of a person or an animal.

If a facial object is not detected from the reference image, the electronic device 110 may present a prompt message to indicate the user to re-upload or re-capture a reference image.

Additionally, as shown in FIG. 2A, the configuration interface 200A may also provide a set of predetermined models, such as model 210 and model 215. In some scenarios, different models may correspond to different video generation qualities.

As an example, the model 210 may support global driving of the reference image. That is, the model 210 may not only generate animation associated with a facial region, but also generate animation associated with other regions cooperatively. In contrast, the model 215 may only support driving of a facial part of the reference image so that the facial region in the reference image presents associated animation.

In some embodiments, the model 210 and the model 215 may correspond to different model architectures. For example, different models may support generating videos of different lengths or different resolutions. Alternatively, the model 210 may also support more types of driving signals than the model 215. As an example, the model 210 may also support a user entering prompt word(s) to generate animation corresponding to non-facial region(s).

Continuing with FIG. 2A, the configuration interface 200A may further include a control 220 (also referred to as a second control). The control 220 may be used to receive a reference text or a reference audio.

As an example, the control 220 may include a text input area, in which a user may input text content as the reference text. In some examples, the text input area may have a predetermined character limit to allow receiving text content not exceeding the limit.

In some embodiments, such text content may also be referred to as “line performance content,” which may correspond to text content to be read aloud. For example, if the text content input by the user includes “The weather is nice today,” the person in the reference image may be driven to present movements (or animations) corresponding to reading aloud “The weather is nice today.”

In some examples, the electronic device 110 may also support the user uploading the reference audio via the control 220. For example, the electronic device 110 may receive a user’s click on a button 225 in the control 220, and may provide options corresponding to one or more ways of uploading a reference audio.

In some examples, the electronic device 110 may support the user recording or uploading a media content (also referred to as first media content) by clicking the button 225. For example, the first media content may include video content or audio content. Further, the electronic device 110 may determine the reference audio based on the obtained first media content.

In some embodiments, the electronic device 110 may also support the user configuring the reference audio by uploading a link. For example, the electronic device 110 may receive link information input by the user, where the link information may correspond to second media content. As an example, the second media content may be video content or audio content.

Further, similar to the first media content, the electronic device 110 may determine the reference audio based on the obtained second media content.

For example, when a length of the first media content or the second media content is less than a preset length, the audio part corresponding to the first media content or the second media content may be determined as the reference audio. In contrast, when the length of the first media content or the second media content reaches a predetermined length, the electronic device 110 may automatically crop the first media content, or may support the user cropping the first media content or the second media content, to determine the reference audio.

Specifically, upon obtaining the first media content or the second media content, the electronic device 110 may present an audio editing interface. The audio editing interface may provide an audio cropping control to support cropping a corresponding clip from the first media content or the second media content.

In some examples, the electronic device 110 may determine a start position and an end position of a desired audio clip based on the user’s operation on the audio cropping control, and may determine the audio clip obtained by cropping as the reference audio.

In some embodiments, in order to facilitate the user performing cropping more efficiently, the electronic device 110 may also present text corresponding to the first media content or the second media content in association with the audio cropping control, to help the user more intuitively perceive the text content corresponding to the retained audio clip.

Taking FIG. 2B as an example, upon obtaining the reference audio, the electronic device 110 may present a schematic waveform diagram of the reference audio in the control 220, and may support the user playing the configured reference audio by clicking a play button. Additionally, the electronic device 110 may also support the user deleting the configured reference audio by clicking a delete button on the right side.

Continuing with FIG. 2A, the configuration interface 200A may further include a timbre selection control (also referred to as a third control). As shown in FIG. 2A, the timbre selection control may be used to determine a target audio parameter to be used. For example, such a target audio parameter may include a timbre parameter. Additionally, such a target audio parameter may also include parameters such as pitch or rhythm.

As shown in FIG. 2A, the timbre selection control may provide multiple candidate audio parameters, such as timbre 235-1, timbre 235-2, and timbre 235-3. As an example, such candidate audio parameters may include predetermined audio parameters in the application 120. As another example, with user authorization, such timbres may also include timbre models pre-built based on user configuration operations (e.g., audio recording operations).

In some examples, the timbre selection control may further provide an upload entry 230 to support the user recording or uploading an audio to determine corresponding audio parameters. For example, upon clicking the upload entry 230, the electronic device 110 may present an audio recording interface and may provide a predetermined text and a recording control.

Further, the user may record audio content corresponding to the predetermined text by clicking the recording control, for determining the audio parameter to be used.

In some scenarios, when the reference audio is obtained via the control 220, the timbre selection control may further support reusing the audio parameter of the reference audio.

Further, after obtaining the above configuration information, the electronic device 110 may receive the user’s click on a generation button 240, to trigger generating video content based on the above configuration information.

In some embodiments, a generative model deployed at the electronic device 110 or the server 130 may be used to generate the video content.

Specifically, the video content generated by the model may include a first movement associated with a first region of the reference image to be driven. Specifically, the first region may include a facial region in the reference image, and the first movement may include animation of the facial region corresponding to reading aloud the reference text or the reference audio, such as mouth movement.

Additionally, the video content may further include a second action associated with a second region of the reference image. In some scenarios, the second region may include other suitable regions different from the facial region, such as a background region of a non-person object or an animal object. Such a background region may be driven to present a second movement coordinated with the first movement.

In some embodiments, the facial region is associated with a predetermined object (e.g., a person object or an animal object) in the reference image, and the second region includes a body region of the predetermined object. That is, the video content generated by the model may include not only animation of the facial part of the person or animal, but also animation of the body of the person or animal.

Additionally, the video content may also include audio content corresponding to the configured target audio parameter (e.g., the timbre parameter). For example, when the configuration information indicates the reference text is “The weather is nice today,” and the target audio parameter is “Timbre 1,” the generated video content may include audio content of reading aloud “The weather is nice today” in “Timbre 1.”

Additionally, when the configuration information indicates the reference audio is an audio clip corresponding to “How is the weather today,” and the target audio parameter is “Timbre 2,” the generated video content may include audio content of reading aloud “How is the weather today” in “Timbre 2.”

In this way, embodiments of the present disclosure may achieve global driving of the reference image, thereby improving the quality of the generated video content.

In some embodiments, the electronic device 110 may further receive a post request from the user for the provided video content, and may accordingly present a post interface 200C as shown in FIG. 2C.

As shown in FIG. 2C, the post interface 200C may present the generated video content 245, and may provide one or more configuration items, such as configuration items 250, 255, and 260. In some embodiments, the configuration items 250 to 260 may be used to set which parts of the configuration information for generating the video content 245 can be made public.

For example, the configuration item 250 may be used to set whether to make the reference image public; the configuration item 255 may be used to set whether to make the reference audio public; and the configuration item 260 may be used to set whether to make the timbre used public.

Further, upon receiving a selection of a post button 265, the electronic device 110 may trigger posting the generated video content 245. For example, the post video content 245 may be associated with a viewing interface 200D as shown in FIG. 2D.

As shown in FIG. 2D, in the viewing interface 200D, the electronic device 110 may present description information associated with the video content 245. For example, the electronic device 110 may present a description word corresponding to the reference image. As another example, the electronic device 110 may present a reading text 275 corresponding to the video content 245.

Additionally, the viewing interface 200D may further include a video generation entry 280 (e.g., “create similar”). Other users may initiate a video generation request by clicking the video generation entry 280, and may access the configuration interface as shown in FIG. 2A.

When accessing the configuration interface via the video generation entry 280, the configuration interface may by default present at least part of the configuration information used for generating the video content 245. As an example, such at least part may be determined based on the configuration items 250 to 260.

For example, when the user chooses to make the “reference image” public, the configuration interface displayed upon being triggered by the video generation entry 280 may by default present, in the first control, the reference image corresponding to the video content 245.

Similarly, when the user chooses to make the “reference audio” public, the configuration interface displayed upon being triggered by the video generation entry 280 may by default provide, in the second control, the reference audio corresponding to the video content 245.

Similarly, when the user chooses to make “my timbre” public, the configuration interface displayed upon being triggered by the video generation entry 280 may by default provide, in the timbre selection control, a timbre selection entry corresponding to the video content 245.

In this way, embodiments of the present disclosure can support other users in quickly creating similar video content, thereby improving the efficiency of video creation.

### Second example

The example interaction process according to embodiments of the present disclosure will be described below with reference to FIG. 3. As an example, FIG. 2A to FIG. 2D may correspond to interaction interfaces of a mobile terminal. The interface 300 shown in FIG. 3 may, for example, correspond to an interface provided on a personal computer.

As shown in FIG. 3, the interface 300 is also referred to as a configuration interface, which may include multiple controls similar to the interface 200A. As an example, a control 305 may be used to obtain the reference image. The interface 300 may further provide multiple generation models of different qualities for selection, such as a model 310, a model 315, and a model 320.

Additionally, similar to the control 220, a control 330 may be used to obtain the reference text or the reference audio. A control 335 may be used to specify a target audio parameter (e.g., a timbre). Additionally, a control 340 may also be used to adjust a reading speed. Similarly, after obtaining configuration information via the interface 300, the electronic device 110 may receive a click on a generation button 345, and may accordingly trigger generating video content.

### Generating Video Content

In some embodiments, the electronic device 110 or the server 130 may determine an audio control signal based on the reference text or the reference audio, and may provide the reference image and the audio control signal to a generative model to generate video content.

As an example, when the configuration information includes the reference text and the timbre parameter, an audio generation model may be used to generate corresponding audio content as the audio control signal.

In some embodiments, when a length of the reference audio exceeds a threshold, the reference audio may be clipped to retain an audio clip satisfying the time length requirement. As an example, the server 130 may determine a highlight clip based on audio information (e.g., volume, rhythm, etc.) and/or text information of the reference audio, and may generate the audio control signal based on the highlight clip for driving the reference image.

In some embodiments, the model may include multiple attention layers. The attention layers may include multimodal attention units, each of which may have three input channels. Specifically, a first channel of the multimodal attention unit may correspond to input video features.

The model may be a generative model based on a diffusion model. Accordingly, video tokens may be obtained by encoding predetermined video content, and noise may be added to the video tokens. As will be described below, the predetermined video content may include other video content associated with the video content to be generated, such as partial video frames from a temporally contiguous previous video clip.

Further, skeleton information may be determined based on reference video content. As an example, skeleton information 225 may characterize a set of key points corresponding to a predetermined object in the reference video content.

Further, an encoding unit may be used to process the skeleton information to determine skeleton features. As an example, the skeleton features may have the same feature size as the video tokens. Further, the video tokens and the skeleton features may be concatenated along a channel dimension to obtain the input video features. As an example, the encoding unit may include a convolutional neural network or another suitable network.

In addition, the multimodal attention unit may further include a second channel. The second channel may correspond to input text features. As an example, when the control signal includes reference text content (e.g., a prompt word), the input text features may include text tokens determined by encoding the reference text content.

Additionally, the multimodal attention unit may further include a third channel. The third channel may correspond to input image features. As an example, the input image features may include reference tokens determined by encoding the reference image.

Further, depending on a modality type of the control signal, the multimodal attention unit may perform an attention-based updating process on at least two types of input features received via the multiple input channels. For example, when the control signal includes the reference video content, the multimodal attention unit may update the input video features and the input image features based on a multimodal attention mechanism.

Further, the attention layers may also include cross-attention units. A cross-attention unit may be associated with two input channels. For example, the cross-attention unit may include a fifth channel corresponding to the input video features updated by the multimodal attention unit.

In addition, the cross-attention unit may further include a sixth channel. The sixth channel may correspond to the input audio features. The input audio features may include audio tokens generated based on reference audio content.

Specifically, when the control signal includes the reference audio content, audio features of the reference audio content may be determined. As an example, the audio features may include Mel-spectrogram features of the audio content. Further, an encoding unit may be used to process the audio features to obtain audio tokens. As an example, the encoding unit may include a multilayer perceptron (MLP) or another suitable model.

Further, the cross-attention unit may update the input video features based on a cross-attention mechanism and based on the audio tokens. Further, the updated input video features may be provided to a multimodal attention unit in a next attention layer.

Similarly, the input text features and the input image features updated by the multimodal attention unit in the attention layer may also be further provided to the multimodal attention unit in the next attention layer. Similarly, the multimodal attention unit may accordingly update the input video features, the input text features, and the input image features.

In this way, after being processed by the multiple attention layers, the model may output final video features to determine a target video.

### Example Process

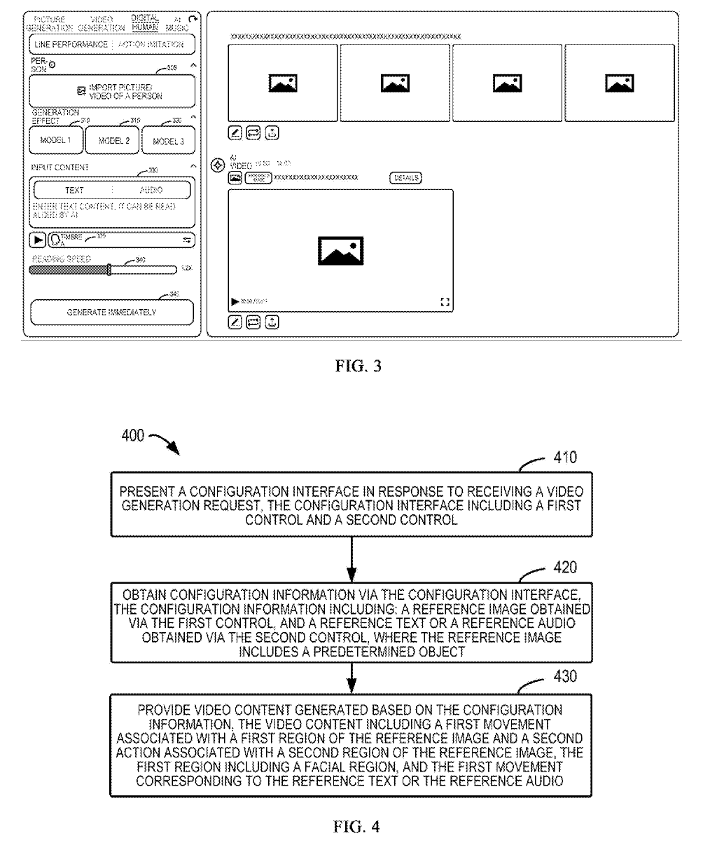

FIG. 4 illustrates a flowchart of an example process 400 of video generation according to some embodiments of the present disclosure. The process 400 may be implemented at the electronic device 110. The process 400 will be described below with reference to FIG. 1.

As shown in the figure, at block 410, the electronic device 110 presents a configuration interface in response to receiving a video generation request, the configuration interface including a first control and a second control.

At block 420, the electronic device 110 obtains configuration information via the configuration interface, the configuration information including: a reference image obtained via the first control, and a reference text or a reference audio obtained via the second control, where the reference image includes a predetermined object.

At block 430, the electronic device 110 provides video content generated based on the configuration information, the video content including a first movement associated with a first region of the reference image and a second action associated with a second region of the reference image, the first region including a facial region, and the first movement corresponding to the reference text or the reference audio.

In some embodiments, the facial region is associated with a predetermined object in the reference image, and the second region includes a body region of the predetermined object.

In this way, embodiments of the present disclosure can not only achieve driving of the facial part but also driving of the body part, thereby improving the quality of the generated video.

In some embodiments, obtaining the configuration information via the configuration interface includes: obtaining text content input in the second control as the reference text.

In this way, embodiments of the present disclosure can support a user in inputting text to be read aloud, thereby achieving control of the generation of video content.

In some embodiments, obtaining the configuration information via the configuration interface includes: obtaining, via the second control, first media content that is recorded or uploaded; and determining the reference audio based on the first media content.

In this way, embodiments of the present disclosure can support a user in inputting reference audio for driving, thereby achieving control of the generation of video content.

In some embodiments, determining the reference audio based on the first media content includes: presenting, in response to obtaining the first media content, an audio editing interface for editing first audio content of the first media content; and determining, via the audio editing interface, an audio clip of the first audio content as the reference audio.

In this way, embodiments of the present disclosure can support a user in selecting an audio clip, thereby improving the quality of the generated video content.

In some embodiments, obtaining the reference audio via the second control includes: obtaining, via the second control, link information corresponding to second media content; and determining the reference audio based on the second media content.

In this way, embodiments of the present disclosure can support a user in specifying reference audio via a link, thereby improving the efficiency of video generation.

In some embodiments, the configuration interface further includes a third control, and obtaining the configuration information via the configuration interface further includes: determining a target audio parameter via the third control, where the generated video content includes second audio content corresponding to the target audio parameter.

In this way, embodiments of the present disclosure can further support configuration of audio attributes, thereby improving the quality of the generated video content.

In some embodiments, determining the audio parameter via the third control includes: providing a plurality of candidate audio parameters in the third control; and receiving a selection of the target audio parameter from the plurality of candidate audio parameters.

In this way, embodiments of the present disclosure can provide predetermined audio parameters, thereby reducing the user’s learning cost.

In some embodiments, determining the audio parameter via the third control includes: obtaining, via the third control, second audio content that is recorded or uploaded; and determining the target audio parameter based on the second audio content.

In this way, embodiments of the present disclosure can support a user in customizing audio parameters, thereby improving the quality of video generation.

In some embodiments, the process 400 further includes: posting the video content in response to receiving a post request for the video content; and presenting a video generation entry in a viewing interface for the video content, the video generation entry being configured to trigger presentation of the configuration interface.

In this way, embodiments of the present disclosure can support other users in performing video generation more conveniently.

In some embodiments, the video generation entry is configured to trigger presentation of at least part of the configuration information in the configuration interface, where the at least part is determined based on the post request.

In this way, embodiments of the present disclosure can support other users in reusing configuration information for video generation, thereby lowering the creation threshold.

In some embodiments, in response to a length of the reference audio exceeding a threshold, the first movement of the video content corresponds to a target clip of the reference audio, and the target clip is determined from the reference audio based on audio information and/or text information of the reference audio.

In this way, embodiments of the present disclosure can improve the quality of the audio clip used for driving video generation.

In some embodiments, the video content is generated based on a process of: determining an audio control signal based on the reference text or the reference audio; and generating the video content by providing the reference image and the audio control signal to a generative model.

In this way, embodiments of the present disclosure can achieve efficient video driving.

### Example Apparatus and Device

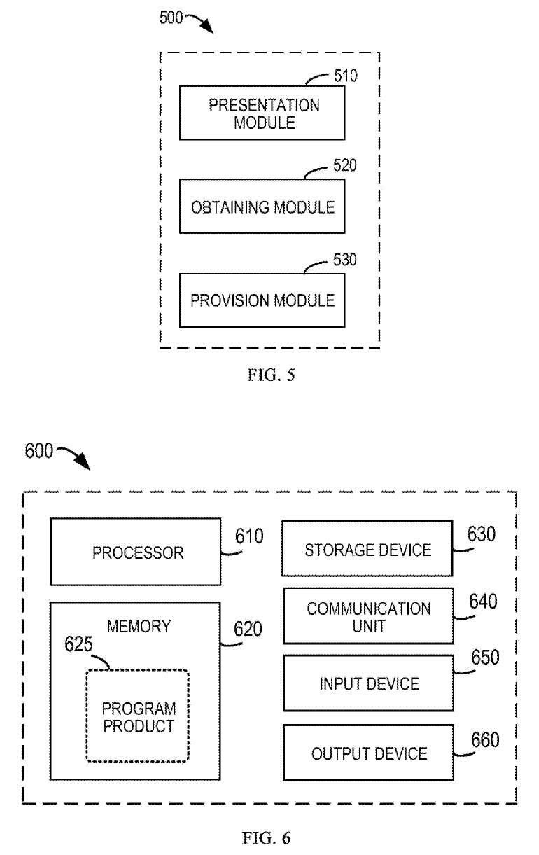

Embodiments of the present disclosure further provide a corresponding apparatus for implementing the above method or process. FIG. 5 illustrates a schematic structural block diagram of an example apparatus 500 for video generation according to some embodiments of the present disclosure. The apparatus 500 may be implemented as, or included in, the electronic device 110. Each module/component in the apparatus 500 may be implemented by hardware, software, firmware, or any combination thereof.

As shown in FIG. 5, the apparatus 500 includes: a presentation module 510 configured to present a configuration interface in response to receiving a video generation request, the configuration interface including a first control and a second control; an obtaining module 520 configured to obtain configuration information via the configuration interface, the configuration information including: a reference image obtained via the first control, and a reference text or a reference audio obtained via the second control, where the reference image includes a predetermined object; and a provision module 530 configured to provide video content generated based on the configuration information, the video content including a first movement associated with a first region of the reference image and a second action associated with a second region of the reference image, the first region including a facial region, and the first movement corresponding to the reference text or the reference audio.

In some embodiments, the facial region is associated with the predetermined object in the reference image, and the second region includes a body region of the predetermined object.

In some embodiments, the obtaining module 520 is further configured to obtain text content input in the second control as the reference text.

In some embodiments, the obtaining module 520 is further configured to: obtain, via the second control, first media content that is recorded or uploaded; and determine the reference audio based on the first media content.

In some embodiments, the obtaining module 520 is further configured to: present, in response to obtaining the first media content, an audio editing interface for editing first audio content of the first media content; and determine, via the audio editing interface, an audio clip of the first audio content as the reference audio.

In some embodiments, the obtaining module 520 is further configured to: obtain, via the second control, link information corresponding to second media content; and determine the reference audio based on the second media content.

In some embodiments, the configuration interface further includes a third control, and the obtaining module 520 is further configured to determine a target audio parameter via the third control, where the generated video content includes second audio content corresponding to the target audio parameter.

In some embodiments, the obtaining module 520 is further configured to: provide a plurality of candidate audio parameters in the third control; and receive a selection of the target audio parameter from the plurality of candidate audio parameters.

In some embodiments, the obtaining module 520 is further configured to: obtain, via the third control, second audio content that is recorded or uploaded; and determine the target audio parameter based on the second audio content.

In some embodiments, the apparatus 500 further includes a posting module configured to post the video content in response to receiving a post request for the video content; and to present a video generation entry in a viewing interface of the video content, the video generation entry being configured to trigger presentation of the configuration interface.

In some embodiments, the video generation entry is configured to trigger presentation of at least part of the configuration information in the configuration interface, where the at least part is determined based on the post request.

In some embodiments, in response to a length of the reference audio exceeding a threshold, the first movement of the video content corresponds to a target clip of the reference audio, and the target clip is determined from the reference audio based on audio information and/or text information of the reference audio.

In some embodiments, the video content is generated based on a process of: determining an audio control signal based on the reference text or the reference audio; and generating the video content by providing the reference image and the audio control signal to a generative model.

The modules included in the apparatus 500 may be implemented in various ways, including software, hardware, firmware, or any combination thereof. In some embodiments, one or more units may be implemented using software and/or firmware, such as machine-executable instructions stored on a storage medium. In addition to, or as an alternative to, the machine-executable instructions, some or all of the modules in the apparatus 500 may be implemented at least partially by one or more hardware logic components. By way of example and not limitation, example types of hardware logic components that may be used include Field Programmable Gate Arrays (FPGAs), Application Specific Integrated Circuits (ASICs), Application Specific Standard Products (ASSPs), System on Chips (SOCs), Complex Programmable Logic Devices (CPLDs), and the like.

FIG. 6 is a block diagram of an electronic device 600 in which one or more embodiments of the present disclosure may be implemented. It should be understood that the electronic device 600 shown in FIG. 6 is only illustrative, and should not constitute any limitation on the functionality and scope of the embodiments described herein. The electronic device 600 shown in FIG. 6 may be used to implement the electronic device 110 of FIG. 1.

As shown in FIG. 6, the electronic device 600 is in the form of a general-purpose electronic device. The components of the electronic device 600 may include, but are not limited to, one or more processors or processing units 610, a memory 620, a storage device 630, one or more communication units 640, one or more input devices 650, and one or more output devices 660. The processing unit 610 may be a physical or virtual processor, and may execute various processes based on the programs stored in the memory 620. In a multi-processor system, multiple processing units execute computer-executable instructions in parallel to improve the parallel processing capability of the electronic device 600.

The electronic device 600 typically includes multiple computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium, such as a flash drive, a disk, or any other medium, which may be used to store information and/or data and may be accessed within the electronic device 600.

The electronic device 600 may further include additional removable/non-removable, volatile/non-volatile storage medium. Although not shown in FIG. 6, a disk drive for reading from or writing to a removable, non-volatile disk (such as a "floppy disk"), and an optical disk drive for reading from or writing to a removable, non-volatile optical disk may be provided. In these cases, each drive may be connected to a bus (not shown) by one or more data medium interfaces. The memory 620 may include a computer program product 625, which has one or more program modules configured to perform various methods or actions of the various embodiments of the present disclosure.

The communication unit 640 enables communication with other electronic devices through the communication medium. In addition, the functions of the components of the electronic device 600 may be implemented in a single computing cluster or multiple computing machines, which may communicate through the communication connection. Therefore, the electronic device 600 may use a logical connection with one or more other servers, a network personal computer (PC), or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may further communicate with one or more external devices (not shown) as needed via the communication unit 640, the external devices such as a storage device, a display device, etc., communicate with one or more devices that enable the user to interact with the electronic device 600, or communicate with any device (for example, a network card, a modem, etc.) that enables the electronic device 600 to communicate with one or more other electronic devices. Such communication may be performed via input/output (I/O) interfaces (not shown).

According to an example implementation of the present disclosure, a computer-readable storage medium is provided, which stores computer-executable instructions, and the computer-executable instructions are executed by a processor to implement the method described above. According to an example implementation of the present disclosure, there is also provided a computer program product, which is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, create an apparatus for implementing the functions/actions specified in one or more blocks of the flowchart and/or block diagram. These computer-readable program instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the functions/actions specified in one or more blocks of the flowchart and/or block diagram.

The computer-readable program instructions may be loaded onto a computer, another programmable data processing apparatus, or other devices, so that a series of operation steps are performed on the computer, the another programmable data processing apparatus, or the other devices to generate a computer-implemented process, such that the instructions executed on the computer, the another programmable data processing apparatus, or the other devices implement the functions/actions specified in one or more blocks of the flowchart and/or block diagram.

The flowchart and block diagram in the drawings show the possibly implemented architectures, functions, and operations of the system, method, and computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of blocks in the block diagram and/or the flowchart may be implemented by a special-purpose hardware-based system that executes specified functions or actions, or may be implemented by a combination of special-purpose hardware and computer instructions.

The implementations of the present disclosure have been described above, and the above description is illustrative, non-exhaustive, and not limited to the disclosed implementations. Without departing from the scope and gist of the described implementations, many modifications and changes will be apparent to those of ordinary skill in the art. The terms used herein are chosen to best explain the principles of the implementations, the practical applications, or the improvements to the technologies in the market, or to enable other ordinary skilled persons in the art to understand the implementations disclosed herein.

I/We claim:

1. A method for video generation, comprising:
presenting a configuration interface in response to receiving a video generation request, the configuration interface comprising a first control and a second control;
obtaining configuration information via the configuration interface, the configuration information comprising: a reference image obtained via the first control, and a reference text or a reference audio obtained via the second control, wherein the reference image comprises an object; and
providing video content generated based on the configuration information, the video content comprising a first movement associated with a first region of the reference image and a second action associated with a second region of the reference image, the first region comprising a facial region, and the first movement corresponding to the reference text or the reference audio.

2. The method of claim 1, wherein the facial region is associated with the object in the reference image, and the second region comprises a body region of the object.

3. The method of claim 1, wherein obtaining the configuration information via the configuration interface comprises:
obtaining text content input in the second control as the reference text.

4. The method of claim 1, wherein obtaining the configuration information via the configuration interface comprises:
obtaining, via the second control, first media content that is recorded or uploaded; and
determining the reference audio based on the first media content.

5. The method of claim 4, wherein determining the reference audio based on the first media content comprises:
presenting, in response to obtaining the first media content, an audio editing interface for editing first audio content of the first media content; and
determining, via the audio editing interface, an audio clip of the first audio content as the reference audio.

6. The method of claim 1, wherein obtaining the reference audio via the second control comprises:
obtaining, via the second control, link information corresponding to second media content; and
determining the reference audio based on the second media content.

7. The method of claim 1, wherein the configuration interface further comprises a third control, and obtaining the configuration information via the configuration interface further comprises:
determining an audio parameter via the third control, wherein the generated video content comprises second audio content corresponding to the audio parameter.

8. The method of claim 7, wherein determining the audio parameter via the third control comprises:
providing a plurality of candidate audio parameters in the third control; and
receiving a selection of the audio parameter from the plurality of candidate audio parameters.

9. The method of claim 7, wherein determining the audio parameter via the third control comprises:
obtaining, via the third control, the second audio content that is recorded or uploaded; and
determining the audio parameter based on the second audio content.

10. The method of claim 1, further comprising:
posting the video content in response to receiving a post request for the video content; and
presenting a video generation entry in a viewing interface for the video content, the video generation entry being configured to trigger presentation of the configuration interface.

11. The method of claim 10, wherein the video generation entry is configured to trigger presentation of at least part of the configuration information in the configuration interface, wherein the at least part is determined based on the post request.

12. The method of claim 1, wherein:
in response to a duration of the reference audio exceeding a threshold, the first movement of the video content corresponds to a clip of the reference audio, and the clip is determined from the reference audio based on at least one of audio information or text information of the reference audio.

13. The method of claim 1, wherein the video content is generated by:
determining an audio control signal based on the reference text or the reference audio; and
generating the video content by providing the reference image and the audio control signal to a generative model.

14. An electronic device, comprising:
at least one processor; and
at least one memory coupled to the at least one processor and storing instructions for execution by the at least one processor, the instructions, when executed by the at least one processor, causing the electronic device to perform acts comprising:
presenting a configuration interface in response to receiving a video generation request, the configuration interface comprising a first control and a second control;
obtaining configuration information via the configuration interface, the configuration information comprising: a reference image obtained via the first control, and a reference text or a reference audio obtained via the second control, wherein the reference image comprises an object; and
providing video content generated based on the configuration information, the video content comprising a first movement associated with a first region of the reference image and a second action associated with a second region of the reference image, the first region comprising a facial region, and the first movement corresponding to the reference text or the reference audio.

15. The electronic device of claim 14, wherein the facial region is associated with the object in the reference image, and the second region comprises a body region of the object.

16. The electronic device of claim 14, wherein obtaining the configuration information via the configuration interface comprises:
obtaining text content input in the second control as the reference text.

17. The electronic device of claim 14, wherein obtaining the configuration information via the configuration interface comprises:
obtaining, via the second control, first media content that is recorded or uploaded; and
determining the reference audio based on the first media content.

18. The electronic device of claim 17, wherein determining the reference audio based on the first media content comprises:
presenting, in response to obtaining the first media content, an audio editing interface for editing first audio content of the first media content; and
determining, via the audio editing interface, an audio clip of the first audio content as the reference audio.

19. The electronic device of claim 14, wherein obtaining the reference audio via the second control comprises:
obtaining, via the second control, link information corresponding to second media content; and
determining the reference audio based on the second media content.

20. A non-transitory computer-readable storage medium having a computer program stored thereon, wherein the computer program, when executed by a processor, perform acts comprising:
presenting a configuration interface in response to receiving a video generation request, the configuration interface comprising a first control and a second control;
obtaining configuration information via the configuration interface, the configuration information comprising: a reference image obtained via the first control, and a reference text or a reference audio obtained via the second control, wherein the reference image comprises an object; and
providing video content generated based on the configuration information, the video content comprising a first movement associated with a first region of the reference image and a second action associated with a second region of the reference image, the first region comprising a facial region, and the first movement corresponding to the reference text or the reference audio.
